(19) United States
(12) Patent Application Publication
(10) Pub. No.: US 2025/0292940 A1
(43) Pub. Date: Sep. 18, 2025

(54) MAGNETIC FIELD GENERATING DEVICE AND MAGNETIC REFRIGERATION APPARATUS USING SAME

(71) Applicant: Hitachi, Ltd., Tokyo (JP)

(72) Inventor: Hiroyuki YAMAMOTO, Tokyo (JP)

(21) Appl. No.: 19/023,543

(22) Filed: Jan. 16, 2025

(30) Foreign Application Priority Data
Mar. 14, 2024 (JP) 2024-039536

(51) Int. Cl. H01F 7/02; F25B 21/00

(52) U.S. Cl. CPC H01F 7/0278; F25B 21/00; F25B 2321/0022

(57) ABSTRACT

There is provided a magnetic field generating device including at least one pair of magnetic pole portions provided to face each other with a space gap sandwiched therebetween. Each of the magnetic pole portions includes a soft magnetic material and a permanent magnet. At least two of the magnetic pole portions are magnetically connected by a common yoke. At least two of the magnetic pole portions connected to the common yoke each have N (N≥2) magnetic flux routes existing between the magnetic pole portion and the common yoke connected thereto by a magnetic material.

### CROSS-REFERENCE TO RELATED APPLICATION

This application claims priority to Japanese Patent Application No. 2024-39536 filed on Mar. 14, 2024, the entire contents of which are incorporated by reference herein.

### BACKGROUND OF THE INVENTION

### 1. Field of the Invention

The present invention relates to a magnetic field generating device and a magnetic refrigeration apparatus using the same.

### 2. Description of Related Art

A vapor-compression refrigeration type refrigerator using a refrigerant gas such as an alternative fluorocarbon gas is widely used for an air conditioner and a refrigerator, and magnetic refrigeration is known as a different cooling technique that does not use a refrigerant gas.

The magnetic refrigeration utilizes a magneto-caloric effect, in which when a magnetic field is applied (excited) to a ferromagnetic material in an adiabatic state, heat is generated, and conversely, when the magnetic field is removed (demagnetized), heat is absorbed. In a magnetic refrigeration apparatus, a ferromagnetic material used for utilizing the magneto-caloric effect is referred to as a magnetic working substance. In a magnetic refrigeration apparatus that operates at a room temperature region, a heat pump is implemented, which transports heat through heat exchange by flowing a heat-exchanging liquid, such as water, in a vessel filled with a magnetic working substance, in conjunction with application and removal of a high magnetic field to the magnetic working substance at a constant period of time.

As the magnetic refrigeration apparatus that operates at a room temperature region, there has been known an example of a magnetic field generating device including a magnetic circuit using a permanent magnet to prevent power consumption. For example, FIGS. 3 and 4 in PTL 1 disclose a permanent magnet magnetic circuit having a Halbach array provided in a circular ring shape. In PTL 1, a plurality of permanent magnets having different magnetization directions are arranged in a doughnut shape, and the permanent magnets are provided in pairs, thereby generating a strong magnetic field only in a part of a space gap sandwiched between the permanent magnets. A duct filled with a magnetic working substance is provided in the space gap, and excitation and demagnetization of the magnetic working substance can be implemented by rotating a pair in a circular annular Halbach array.

### Citation List

### Patent Literature

PTL 1: JP2011-226735A

### SUMMARY OF THE INVENTION

However, in the technique disclosed in PTL 1, a cost of the apparatus may increase when all components of the permanent magnet magnetic circuit having a Halbach array provided in a circular ring shape are configured with a permanent magnet, and a neodymium magnet is used as a permanent magnet material for obtaining a magnetic field sufficient for practical use (a typical magnetic flux density of 1 T or more).

The problem to be solved by the invention is to provide a magnetic field generating device capable of generating a strong magnetic field using a small amount of permanent magnets, and a magnetic refrigeration apparatus using the same.

In order to solve the above problem, a magnetic field generating device of the invention is a magnetic field generating device including at least one pair of magnetic pole portions provided to face each other with a space gap sandwiched therebetween, in which each of the magnetic pole portions includes a soft magnetic material and a permanent magnet, at least two of the magnetic pole portions are magnetically connected by a common yoke, and at least two of the magnetic pole portions connected to the common yoke each have N (N≥2) magnetic flux routes existing between the magnetic pole portion and the common yoke connected thereto by a magnetic material.

A magnetic refrigeration apparatus of the invention is a magnetic refrigeration apparatus using the above-described magnetic field generating device. The magnetic refrigeration apparatus includes: a rotation mechanism configured to rotate the magnetic field generating device; a filling vessel provided at least partially within the space gap sandwiched between the pair of magnetic pole portions of the magnetic field generating device; a pump configured to circulate a heat-exchanging fluid; a cold head to be cooled by the heat-exchanging fluid; a heat-exhausting heat exchanger configured to exhaust heat from the heat-exchanging fluid; and a movable valve configured to control a flow of the heat-exchanging fluid in conjunction with movement of the rotation mechanism. The magnetic field generating device rotates about a predetermined axis, the filling vessel is filled with a magnetic working substance, the filling vessel, the pump, the cold head, the heat-exhausting heat exchanger, and the movable valve are connected by a pipe to form a circulation path through which the heat-exchanging fluid circulates, and the cold head is cooled by a magnetic field generated by the magnetic field generating device and a magneto-caloric effect of the magnetic working substance.

According to the invention, the magnetic pole portion includes the soft magnetic material and the permanent magnet, and thus an amount of the permanent magnet can be reduced, and by providing a plurality of magnetic flux routes, the magnetic flux increases and a strong magnetic field can be generated. Therefore, a magnetic field generating device capable of generating a strong magnetic field using a small amount of permanent magnets, and a magnetic refrigeration apparatus using the same can be implemented.

### BRIEF DESCRIPTION OF THE DRAWINGS

FIG. 1 is a perspective view of a magnetic field generating device according to a first embodiment;

FIG. 2 is a longitudinal sectional view taken along an axis A in FIG. 1; FIG. 3 is a cross-sectional view taken along the axis A in FIG. 1;

FIG. 4 is a cross-sectional view taken along a line B-B′ in FIG. 3;

FIG. 5 is a longitudinal sectional view schematically illustrating a magnetic refrigeration apparatus of a second embodiment;

FIG. 6 is a cross-sectional view taken along an axis A in FIG. 5;

FIG. 7 is a perspective view schematically illustrating a filling vessel in the magnetic refrigeration apparatus of the second embodiment; and

FIG. 8 is a perspective view of a magnetic field generating device of a third embodiment.

### DESCRIPTION OF EMBODIMENTS

Hereinafter, an embodiment of the disclosure will be described in more detail in each embodiment, but the disclosure content of each embodiment is not limited to only the description of the embodiment, and a configuration in which the disclosure of each embodiment or an element technique to be taught is appropriately combined within the scope of knowledge of a person skilled in the art is also included in the scope of the present embodiment. In each of the drawings and each of the embodiments, the same or similar components are denoted by the same reference numerals, and redundant description thereof is omitted.

### First Embodiment

A first embodiment proposes a configuration of a magnetic field generating device.

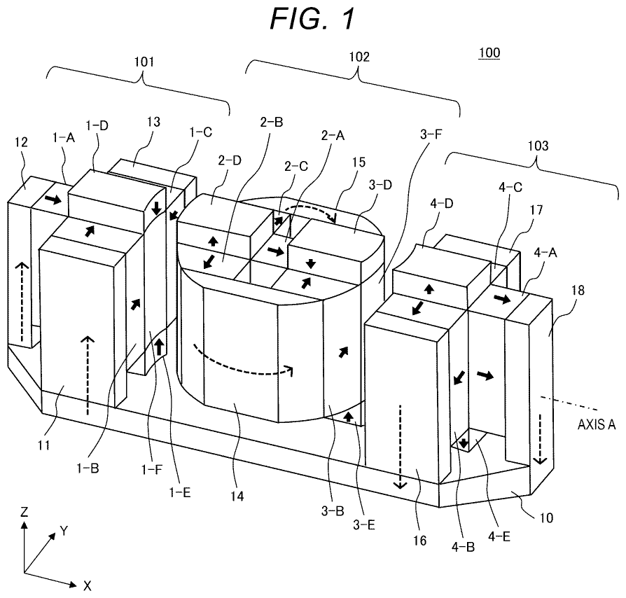

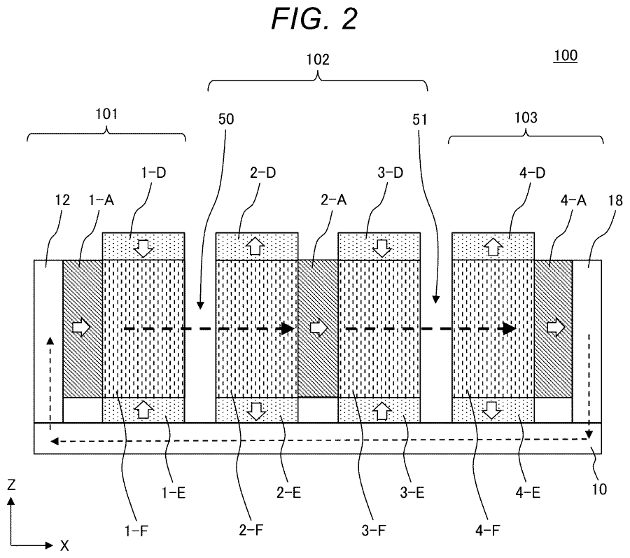

FIG. 1 is a perspective view of the magnetic field generating device of the first embodiment. FIG. 2 is a longitudinal sectional view taken along an axis A in FIG. 1. FIG. 3 is a cross-sectional view taken along the axis A in FIG. 1.

A magnetic field generating device 100 of the present embodiment has at least one pair of magnetic pole portions provided to face each other with a space gap sandwiched therebetween. In the present embodiment, an example will be described in which there is a total of two pairs of magnetic pole portions, one pair of magnetic pole portions provided to face each other with a space gap 50 sandwiched therebetween and one pair of magnetic pole portions provided to face each other with a space gap 51 sandwiched therebetween. However, the invention is not limited thereto, and there may be one pair or three or more pairs.

The magnetic field generating device 100 of the present embodiment includes a base yoke 10, which is a common yoke, and three blocks 101, 102, and 103 with two space gaps 50 and 51 sandwiched therebetween.

The block 101 includes one of the pair of magnetic pole portions provided to face each other with the space gap 50 sandwiched therebetween, and yokes 11, 12, and 13.

The magnetic pole portion includes a soft magnetic material and a permanent magnet, and five permanent magnets 1-A, 1-B, 1-C, 1-D, and 1-E are provided around a soft magnetic core 1-F which is a core of the soft magnetic material. The number of permanent magnets may be at least N or more when the number of magnetic flux routes to be described later is N (N>2). In the present embodiment, an example will be described in which the number of magnetic flux routes is N=4 and the number of permanent magnets is five. As in the present embodiment, the magnetic pole portion includes the soft magnetic material and the permanent magnet, and thus an amount of permanent magnets can be reduced.

Solid arrows illustrated in the permanent magnets 1-A, 1-B, 1-C, 1-D, and 1-E in FIG. 1 and arrow symbols illustrated in the permanent magnets 1-A, 1-B, 1-C, 1-D, and 1-E in FIGS. 2 and 3 represent magnetization directions of the permanent magnets. All magnetization directions are provided in a Halbach array for concentrating magnetic flux on the soft magnetic core 1-F, and the soft magnetic core 1-F is magnetized to a first polarity. As illustrated in FIG. 1, the permanent magnets 1-A, 1-B, and 1-C are magnetically and mechanically connected to the base yoke 10, which is a common yoke, by yokes 11, 12, and 13, respectively. Accordingly, as an operation of an entire magnetic circuit, a magnetic flux flowing through the base yoke 10 flows through the yokes 11, 12, and 13 and the permanent magnets 1-A, 1-B, and 1-C with three magnetic flux routes of the yokes 11, 12, and 13 to the soft magnetic core 1-F, as illustrated by dotted arrows in FIG. 1 (a magnetic flux flowing through the yoke 13 is hidden and not illustrated). The permanent magnet 1-E is in contact with the base yoke 10, and is one of the magnetic flux routes through which the magnetic flux flowing through the base yoke 10 flows to the soft magnetic core 1-F. Accordingly, the magnetic pole portion in the block 101 that is connected to the base yoke 10, which is a common yoke, has N=4 magnetic flux routes existing between the magnetic pole portion and the common yoke connected thereto by a magnetic material (a yoke or a permanent magnet). The magnetic flux concentrated in the soft magnetic core 1-F in this manner generates a magnetic field in a +X direction in the space gap 50, as illustrated in FIG. 2, and the magnetic flux enters the magnetic pole portion in the adjacent block 102. As in the present embodiment, a plurality of magnetic flux routes exist between the magnetic pole portion and the common yoke connected thereto by the magnetic material (the yoke or the permanent magnet) instead of a space, and thus the magnetic flux increases and a strong magnetic field can be generated. Therefore, a strong magnetic field can be generated using a small amount of permanent magnets.

The block 102 has a structure in which two magnetic pole portions are connected. Specifically, the block 102 includes the other one of the pair of magnetic pole portions provided to face each other with the space gap 50 sandwiched therebetween, one of a pair of magnetic pole portions provided to face each other with the space gap 51 sandwiched therebetween, and yokes 14 and 15 connecting the two magnetic pole portions. Like the magnetic pole portion in the block 101, the magnetic pole portions in the block 102 each have a Halbach array structure including a soft magnetic core and five permanent magnets.

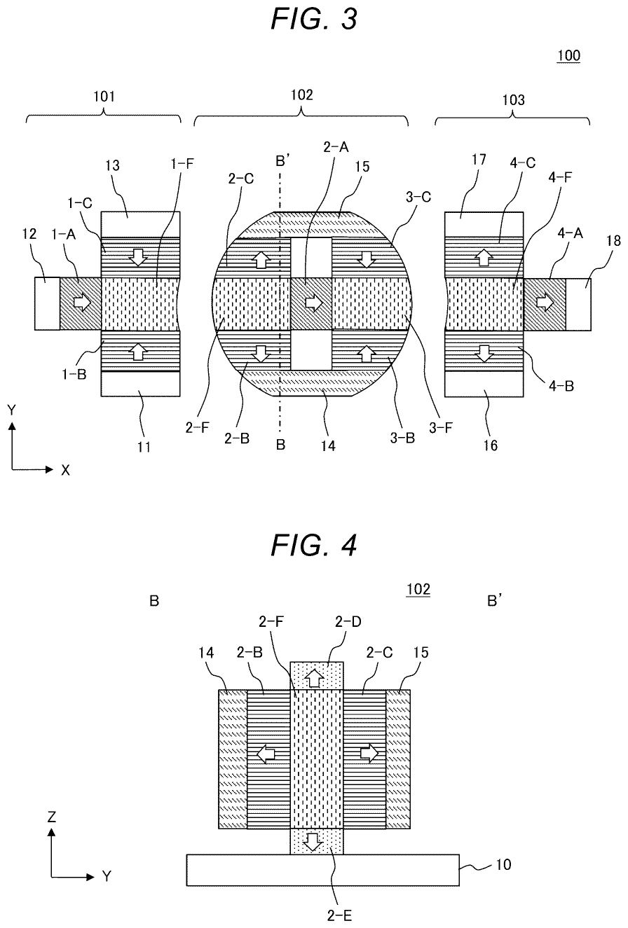

FIG. 4 is a cross-sectional view taken along a line B-B′ in FIG. 3.

As illustrated in FIG. 4, four permanent magnets 2-B, 2-C, 2-D, and 2-E magnetized in mutually repelling directions are provided on upper, lower, left, and right sides of a soft magnetic core 2-F. As illustrated in FIG. 3, the soft magnetic core 2-F and a soft magnetic core 3-F are connected to each other by a permanent magnet 2-A common to the soft magnetic core 2-F and the soft magnetic core 3-F, and a magnetization direction of the permanent magnet 2-A is also a direction that repels those of the permanent magnets 2-B, 2-C, 2-D, and 2-E. Thus, the soft magnetic core 2-F is magnetized to a second polarity.

Returning to FIG. 2, the magnetic flux entering the soft magnetic core 2-F of the magnetic pole portion facing the space gap 50 flows through the permanent magnet 2-A to the soft magnetic core 3-F of the adjacent magnetic pole portion. At the same time, as schematically indicated by the dotted arrows in FIG. 1, the magnetic flux entering the soft magnetic core 2-F flows through the permanent magnets 2-B and 2-C, the yokes 14 and 15, and the permanent magnets 3-B and 3-C to the soft magnetic core 3-F. As illustrated in FIG. 2, the magnetic flux concentrated in the soft magnetic core 3-F generates a magnetic field in the +X direction in the space gap 51, and the magnetic flux enters the magnetic pole portion of the adjacent block 103. The soft magnetic core 3-F is magnetized to the first polarity by magnetization directions of permanent magnets 3-A, 3-B, 3-C, 3-D, and 3-E. The number of magnetic flux routes in the two magnetic pole portions in the block 102 is one each through the permanent magnets 2-E and 3-E.

The block 103 includes the other one of the pair of magnetic pole portions provided to face each with the space gap 51 sandwiched therebetween, and yokes 16, 17, and 18.

A structure of the block 103 is the same as that of the block 102 except for an arrangement of magnetization directions of the permanent magnet. A soft magnetic core 4-F is magnetized to the second polarity by magnetization directions of permanent magnets 4-A, 4-B, 4-C, 4-D, and 4-E. Similar to the block 101, the magnetic flux reaching the block 103 flows through a total of N=4 magnetic flux routes, i.e., three magnetic flux routes along the yokes 16, 17, and 18 and one magnetic flux route passing through the permanent magnet 4-E, to the base yoke 10, passes through the three yokes 11, 12, and 13 in the block 101 and the permanent magnet 1-E, and enters the soft magnetic core 1-F in the block 101. In terms of the entire magnetic circuit, in the magnetic field generating device 100 of the present embodiment, the magnetic flux as indicated by the dotted arrows in FIG. 2 circulates, and a strong magnetic field is generated in the space gaps 50 and 51.

The permanent magnets 1-D, 1-E, 2-D, 2-E, 3-D, 3-E, 4-D, and 4-E provided in a Z direction of the soft magnetic core act in a direction to confine the magnetic flux that tends to spread in +Z-axis directions within the space gaps 50 and 51, and these permanent magnets also effectively work to increase a magnetic field intensity within the space gaps 50 and 51.

According to the present embodiment, the magnetic pole portion includes the soft magnetic material and the permanent magnet, and thus the amount of permanent magnets can be reduced as compared with the case where the magnetic pole portion is composed entirely of the permanent magnet, and by providing a plurality of magnetic flux routes, the magnetic flux increases and a strong magnetic field can be generated. Therefore, a strong magnetic field can be generated using a small amount of permanent magnets.

In the magnetic field generating device 100 of the present embodiment, an intensity of the magnetic field generated by the magnetic field generating device 100 of the present embodiment was calculated by electromagnetic field analysis simulation when dimensions of the soft magnetic cores 1-F, 2-F, 3-F, and 4-F of the magnetic pole portions in a Y-Z plane are 40 mm×100 mm (a longitudinal direction is the Z direction), dimensions of the yokes 11, 12, 13, 16, 17, and 18 in the longitudinal direction (the Z direction) are 120 mm, and a width of the space gaps 50 and 51 (in the X direction) is 26 mm. A neodymium sintered magnet was used as the permanent magnet material. As a result of the calculation, a magnetic flux density of 1.4 T was obtained at centers of the space gaps 50 and 51 in a region sandwiched by the magnetic pole portions. Since a magnetic field sufficient for practical use has a magnetic flux density of, for example, 1 T or more, it is confirmed that the magnetic field sufficient for practical use can be obtained using a smaller amount of permanent magnets according to the present embodiment.

In order to increase the circulating magnetic flux and generate a strong magnetic field, it is sufficient that at least two of the magnetic pole portions connected to the common yoke each have N (N≥2) magnetic flux routes existing between the magnetic pole portion and the common yoke connected thereto by the magnetic material. In the present embodiment, a configuration in which the two magnetic pole portions each having N=4 magnetic flux routes are connected to the common yoke has been described as an example, but the invention is not limited thereto. For example, three or more magnetic pole portions each having N>2 magnetic flux routes may be connected to the common yoke.

As an example in which N=2 or N=3, the number of magnetic flux routes can be adjusted so as to satisfy N=2 or N=3 by not bringing the permanent magnets 1-E and 4-E into contact with the base yoke 10 and sandwiching a space therebetween or by reducing the number of yokes 11, 12, 13, 16, 17, and 18.

In addition, N>4 may be satisfied. For example, the number of magnetic flux routes can be adjusted by making a shape of the soft magnetic core 1-F or the like a polyhedron having more than four side surfaces instead of a cuboid.

The magnetic material to be connected to the common yoke may include a yoke that connects the common yoke and the permanent magnet of the magnetic pole portion, such as the yokes 11, 12, 13, 16, 17, and 18, may include a permanent magnet of the magnetic pole portion that contacts the common yoke, such as the permanent magnets 1-E and 4-E, or may include a permanent magnet that replaces, for example, the yokes 11, 12, 13, 16, 17, and 18 and connects the common yoke and the permanent magnet of the magnetic pole portion. When a permanent magnet is used instead of the yoke, an amount of permanent magnets increases, and thus it is desirable to use the yoke.

In order to mechanically fix the magnetic pole portion while increasing the number of magnetic flux routes, it is desirable to adopt a configuration in which the permanent magnets provided on at least two surfaces, more desirably, three surfaces, as shown in the present embodiment, of the core of the soft magnetic material of the magnetic pole portion that do not face the common yoke and the space gap are connected to the common yoke by the yoke. In the case of two surfaces, it is desirable that the surfaces face each other, and it is desirable that the yokes 12 and 18 are removed and the yokes 11, 13, 16, and 18 are used.

In order for the pair of magnetic pole portions to generate a magnetic field in the space gap, the permanent magnet of one of the pair of magnetic pole portions may be magnetized in a direction in which the core of the soft magnetic material is magnetized to the first polarity, and the permanent magnet of the other one of the pair of magnetic pole portions may be magnetized in a direction in which the core of the soft magnetic material is magnetized to the second polarity. In order to circulate the magnetic flux through the base yoke 10, which is a common yoke, at least one magnetic pole portion including the core of the soft magnetic material magnetized to the first polarity and at least one magnetic pole portion including the core of the soft magnetic material core magnetized to the second polarity may be magnetically connected by the common yoke.

### Second Embodiment

A second embodiment is an example of a magnetic refrigeration apparatus 200 using the magnetic field generating device 100 of the first embodiment.

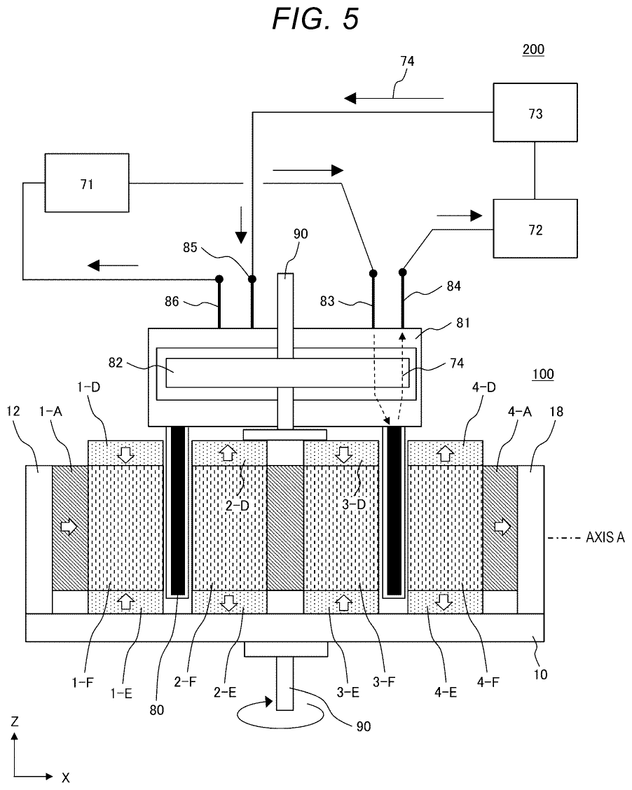

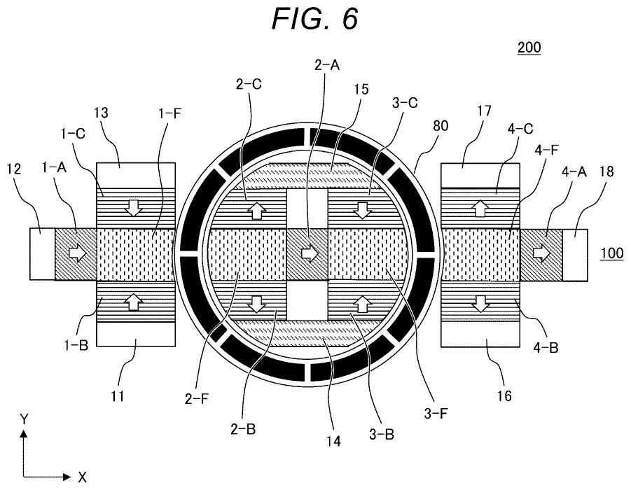

FIG. 5 is a longitudinal sectional view schematically illustrating the magnetic refrigeration apparatus of the second embodiment. FIG. 6 is a cross-sectional view taken along an axis A in FIG. 5.

The magnetic refrigeration apparatus 200 of the present embodiment includes the magnetic field generating device 100, a rotation mechanism (not illustrated), a filling vessel 80, a pump 72, a cold head 71, a heat-exhausting heat exchanger 73, and a movable valve 81.

A configuration of the magnetic field generating device 100 is the same as that in the first embodiment. The filling vessel 80 is provided at least partially within the space gaps 50 and 51. The filling vessel 80 is filled with a magnetic working substance. As the filling vessel 80, for example, a cylindrical vessel can be used. The magnetic field generating device 100 is connected to the rotation mechanism (not illustrated) via a shaft 90, and rotates about an axis of the shaft 90 by the rotation mechanism (not illustrated). The filling vessel 80 is fixed with respect to the movable valve 81, and is separated from the magnetic field generating device 100. Accordingly, even when the magnetic field generating device 100 rotates, the filling vessel 80 and the movable valve 81 can be fixed.

The movable valve 81 houses a flow path control plate 82 therein, and the flow path control plate 82 is connected to the shaft 90 and rotates integrally with the shaft 90. Pipes 83, 84, 85, and 86 are connected to a circulation system in which a heat-exchanging fluid, such as a circulation flow 74, circulates. As a circulation path, the heat-exchanging fluid flows through the pump 72 that circulates a heat-exchanging fluid, the heat-exhausting heat exchanger 73 that exhausts heat from the heat-exchanging fluid, the movable valve 81 that controls a flow of the heat-exchanging fluid in conjunction with movement of the rotation mechanism, the filling vessel 80, the movable valve 81, the cold head 71 to be cooled by the heat-exchanging fluid, the movable valve 81, the filling vessel 80, and the movable valve 81, and returns to the pump 72. An operation during the cooling operation based on the configuration will be described later.

As illustrated in FIG. 6, the filling vessel 80 is a cylindrical vessel, and an inside thereof is divided into a plurality of segments by partitions. Each segment is filled with a magnetic working substance. Here, an example in which the inside is divided into eight regions will be described, but the invention is not limited thereto, as long as the inside is divided into at least four segments.

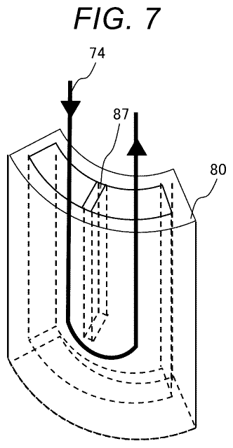

FIG. 7 is a perspective view schematically illustrating the filling vessel in the magnetic refrigeration apparatus of the second embodiment. FIG. 7 shows one divided segment of the filling vessel 80.

A flow path partition 87 that controls a direction of a flow path is installed inside the filling vessel 80, and a heat-exchanging fluid flows through a flow path inside the filling vessel 80 as the circulation flow 74. The flow path is filled with, for example, a granular magnetic working substance (not illustrated), and the heat-exchanging fluid flows through a gap thereof.

Next, the cooling operation performed by the magnetic refrigeration apparatus 200 according to the present embodiment will be described. In the present embodiment, the cold head 71 can be cooled by a magnetic field generated by the magnetic field generating device 100 and a magneto-caloric effect of the magnetic working substance. More specifically, the operation is as follows.

When the magnetic field generating device 100 rotates about the shaft 90, the filling vessel 80 is fixed, so that the magnetic working substance in the filling vessel 80 is repeatedly magnetized and demagnetized at a constant period in conjunction with rotational motion of the magnetic field generating device 100. As can be seen from FIG. 6, when the magnetic field generating device 100 rotates, only in a case where the magnetic pole portion of the magnetic field generating device 100 comes to each divided segments of the filling vessel 80, the segment is excited and the other segments are demagnetized. The heat-exchanging fluid circulating in the magnetic refrigeration apparatus 200 flows through the pipes to the filling vessel 80, and transfers heat by exchanging heat with the magnetic working substance inside.

As illustrated in FIG. 5, the segment in which the magnetic working substance is excited is connected to the pipes 83 and 84 outside the movable valve 81 by the flow path control plate 82, and the heat-exchanging fluid after exchanging heat with the heated magnetic working substance passes through the pipe 84 and returns to the pump 72. Thereafter, the heat-exchanging fluid passes through the heat-exhausting heat exchanger 73 to exhaust heat to the outside. Further, the heat-exchanging fluid passes through the pipe 85 and enters the movable valve 81. At this time, the pipes 85 and 86 are connected, by the flow path control plate 82, to the demagnetized segment, that is, a region where a temperature of the magnetic working substance is lowered. The heat-exchanging fluid whose temperature reduces by passing through the low-temperature segment flows through the pipe 86 to the cold head 71, and the cold head 71 is cooled by the heat-exchanging fluid. Thereafter, the heat-exchanging fluid flows through the pipe 83 from the movable valve 81 to the filling vessel 80.

As described above, the segments to be heated or cooled are switched in synchronization with the rotation of the magnetic field generating device 100, and at the same time, the flow path control plate 82 in the movable valve 81 switches the flow path, whereby high temperature heat is transferred to the heat-exhausting heat exchanger 73 side, and cold is transferred to the cold head 71 to cool the cold head 71.

In the present embodiment, although gadolinium (Gd) is used as the magnetic working substance, a neodymium magnet having Nd₂Fe₁₄B as a main phase is used as the permanent magnet, iron is used as the soft magnetic core and the yoke, and water is used as the heat-exchanging fluid, other materials may be applied. For example, as another material of the magnetic working substance, La(Fe,Si)₁₃ of a metamagnetic material having a high magneto-caloric effect can be applied. The permanent magnet may be a rare earth magnet in which neodymium (Nd) having a Nd₂Fe₁₄B crystal structure is replaced with an inexpensive rare earth element such as La or Ce. The soft magnetic core and the yoke may be made of a ferromagnetic material through which magnetic flux passes, such as iron, cobalt, or nickel.

### Third Embodiment

A third embodiment is an example of a configuration of the magnetic field generating device 100 in which only two blocks each including a magnetic pole portion are provided. Since the third embodiment is a modification of the first embodiment, differences will be mainly described, and redundant description will be omitted.

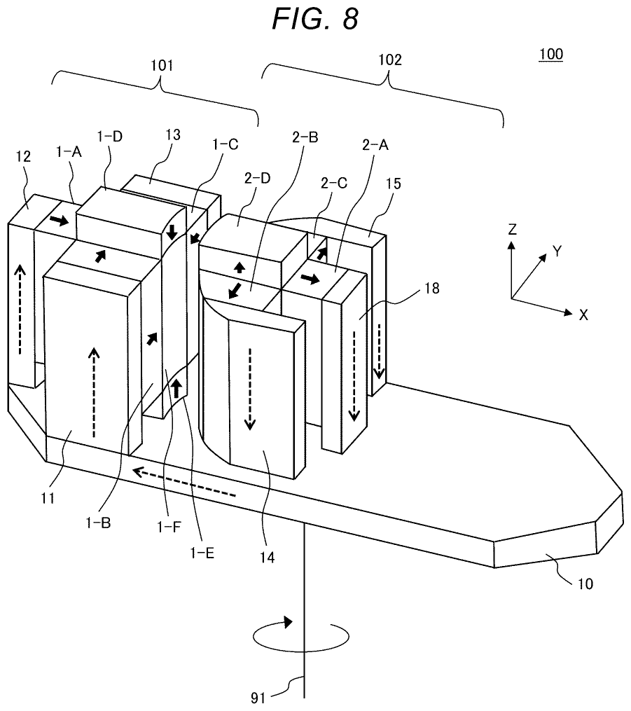

FIG. 8 is a perspective view of a magnetic field generating device of the third embodiment.

A basic configuration of the present embodiment is the same as that of the first embodiment, but in the present embodiment, only one pair of magnetic pole portions is provided, and only two blocks 101 and 102 including the magnetic pole portions, respectively, are provided. A magnetic flux passes through a plurality of yokes 11, 12, and 13 in the block 101 from the base yoke 10, is concentrated in the soft magnetic core 1-F, passes through a space gap, and enters the block 102. From there, the magnetic flux flows through the plurality of yokes 14, 15, and 18 to the base yoke 10.

Also in the present embodiment, similar to the first embodiment, the magnetic flux is concentrated in a soft magnetic core due to a Halbach array configuration of the magnetic pole portion, and a strong magnetic field is generated in the space gap. When applied to the magnetic refrigeration apparatus 200, it is sufficient to implement in a configuration similar to that of the magnetic refrigeration apparatus 200 of the second embodiment, and by rotating around the rotation axis 91, a periodic magnetized or demagnetized state can be implemented in the cylindrical filling vessel 80.

Although the embodiments of the invention have been described above, the invention is not limited to the configurations described in the embodiments, and various modifications can be made within the scope of the technical idea of the invention. Some or all of the configurations described in the embodiments may be combined and applied.

What is claimed is:

1. A magnetic field generating device comprising:
at least one pair of magnetic pole portions provided to face each other with a space gap sandwiched therebetween, wherein
each of the magnetic pole portions includes a soft magnetic material and a permanent magnet,
at least two of the magnetic pole portions are magnetically connected by a common yoke, and
at least two of the magnetic pole portions connected to the common yoke each have N (N≥2) magnetic flux routes existing between the magnetic pole portion and the common yoke connected thereto by a magnetic material.

2. The magnetic field generating device according to claim 1, wherein
in the magnetic pole portion, at least N or more of the permanent magnets are provided around a core of the soft magnetic material,
the permanent magnets of one of the pair of magnetic pole portions are magnetized in a direction in which the core of the soft magnetic material is magnetized to a first polarity, and
the permanent magnets of the other one of the pair of magnetic pole portions are magnetized in a direction in which the core of the soft magnetic material is magnetized to a second polarity.

3. The magnetic field generating device according to claim 2, wherein
at least one of the magnetic pole portions including the core of the soft magnetic material magnetized to the first polarity and at least one of the magnetic pole portions including the core of the soft magnetic material magnetized to the second polarity are magnetically connected by the common yoke.

4. The magnetic field generating device according to claim 1, wherein
N=3.

5. The magnetic field generating devices according to claim 1, wherein
N=4.

6. The magnetic field generating device according to claim 1, wherein
the magnetic material includes a yoke which connects the common yoke and the permanent magnet of the magnetic pole portion.

7. The magnetic field generating device according to claim 1, wherein
the magnetic material includes the permanent magnet of the magnetic pole portion in contact with the common yoke.

8. The magnetic field generating device according to claim 1, wherein
the magnetic material includes a permanent magnet which connects the common yoke and the permanent magnet of the magnetic pole portion.

9. The magnetic field generating device according to claim 1, wherein
in the magnetic pole portion having the N magnetic flux routes existing between the magnetic pole portion and the common yoke, at least N or more of the permanent magnets are provided around a core of the soft magnetic material,
the magnetic material includes a yoke which connects the common yoke and the permanent magnet of the magnetic pole portion, and
each of the permanent magnets provided on at least two surfaces of the core of the soft magnetic material that do not face the common yoke and the space gap is connected to the common yoke by the yoke.

10. The magnetic field generating device according to claim 9, wherein
each of the permanent magnets provided on three surfaces of the core of the soft magnetic material that do not face the common yoke and the space gap is connected to the common yoke by the yoke.

11. A magnetic refrigeration apparatus using the magnetic field generating device according to claim 1, the magnetic refrigeration apparatus comprising:
a rotation mechanism configured to rotate the magnetic field generating device;
a filling vessel provided at least partially within the space gap sandwiched between the pair of magnetic pole portions of the magnetic field generating device;
a pump configured to circulate a heat-exchanging fluid;
a cold head configured to be cooled by the heat-exchanging fluid;
a heat-exhausting heat exchanger configured to exhaust heat from the heat-exchanging fluid; and
a movable valve configured to control a flow of the heat-exchanging fluid in conjunction with movement of the rotation mechanism, wherein
the magnetic field generating device rotates about a predetermined axis,
the filling vessel is filled with a magnetic working substance, the filling vessel, the pump, the cold head, the heat-exhausting heat exchanger, and the movable valve are connected by a pipe to form a circulation path through which the heat-exchanging fluid circulates, and
the cold head is cooled by a magnetic field generated by the magnetic field generating device and a magneto-caloric effect of the magnetic working substance.

12. The magnetic refrigeration apparatus according to claim 11, wherein
the filling vessel is divided into at least four segments.
